(19) United States
(12) Patent Application Publication
(10) Pub. No.: US 2009/0154202 A1
(43) Pub. Date: Jun. 18, 2009

(54) Backlight inverter and method of driving same

(75) Inventors: Shingo Takatsuka, Kitasaku-gun (JP); Mitsuaki Suzuki, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., KITASAKU-GUN (JP)

(21) Appl. No.: 12/292,829

(22) Filed: Nov. 26, 2008

(30) Foreign Application Priority Data
Dec. 13, 2007 (JP) 2007-322191

(51) Int. Cl. H02M 1/00

(52) U.S. Cl. 363/40

(57) ABSTRACT

A backlight inverter is provided which includes at least one inverter transformer and to which a plurality of cold cathode fluorescent lamps are connected, wherein a plurality of primary windings of the inverter transformer are connected to each other either in series or in parallel, a resonance circuit including a leakage inductance and a capacitance component is formed at the secondary side of the inverter transformer, and wherein the inverter transformer is driven at an operating frequency which is included in a frequency range between a parallel resonance frequency and a series resonance frequency of the resonance circuit and which excludes a frequency range between a first inflection point and a second inflection point of a gain characteristic curve of the inverter transformer.

### BACKGROUND OF THE INVENTION

1. Field of the Invention

The present invention relates to a backlight inverter for driving a light source to illuminate a liquid crystal display screen, particularly a backlight inverter for driving a plurality of lamps for a large liquid crystal display television (LCD TV), and also relates to a method of driving such a backlight inverter.

2. Description of the Related Art

While recently a liquid crystal display (LCD) is widely used for use as a display device for a personal computer and the like, a lighting means, such as a backlight, is required for illuminating the screen of the LCD. In order to light the screen of the LCD brightly, a plurality of cold cathode fluorescent lamps (hereinafter referred to as “CCFLs”) are used as a light source, and are simultaneously discharged and lit.

Generally, for discharging and lighting a CCFL for a backlight, an inverter circuit which includes an inverter unit incorporating a full-bridge circuit or a Royer circuit for driving the backlight is used so that with application of a DC input voltage of about 24 V, a high-frequency voltage of 60 kHz and about 1600 V is generated at the secondary side of an inverter transformer when starting the discharge of the CCFL. Once the discharge of the CCFL is started, then the inverter circuit performs control such that the secondary side voltage of the inverter transformer is lowered to about 1000 V to keep discharging the CCFL. This voltage control is usually performed with PWM control.

In some conventional inverter circuits for a backlight, a resonance circuit is composed of a leakage inductance present at the secondary side of a transformer and a parasitic capacitance formed at a discharge lamp connected as a load, and the primary side of the transformer is driven at the resonance frequency of the resonance circuit.

When the transformer is driven at the resonance frequency as described above, however, a phase difference is caused between voltage and current at the primary side of the transformer, and the transformer does not necessarily achieve good power efficiency. Also, a resonance frequency of a high order is present at the secondary side of the transformer, and therefore it can happen that the transformer operates at such a resonance frequency of a high order or that the transformer is likely to be influenced by the resonance frequency during operation, which poses a difficulty in designing a transformer. Also, in a CCFL for a backlight, lamp impedance fluctuates considerably depending on temperature and lamp current, especially immediately after cold starting. Further, a large fluctuation in lamp impedance means fluctuation also in lamp voltage, and consequently the parasitic capacitance formed at the lamp is caused to fluctuate, too.

Under the circumstance described above, an inverter circuit for a discharge lamp is disclosed which includes: a transformer having a resonance circuit including a parasitic capacitance formed at a discharge lamp; and an H-bridge circuit to drive the primary side of the transformer at a frequency which is lower than the resonance frequency of the resonance circuit and also at which a voltage-current phase difference θ at the primary side of the transformer is kept within a predetermined range from the minimum point (refer to, for example, Japanese Patent Application Laid-Open No. 2003-168585).

In the above-described inverter circuit for a discharge lamp disclosed in Japanese Patent Application Laid-Open No. 2003-168585, the transformer achieves enhanced power efficiency, and also the influence from the frequency of a high order is reduced, which reduces the difficulty in designing a transformer.

Also, a method of driving an inverter circuit is disclosed in which oscillating operation is stabilized thereby preventing discharge lamps from flickering and circuit elements from generating noises (refer to, for example, Japanese Patent Application Laid-Open No. 2004-201457). This method is to drive an inverter circuit having a step-up transformer in which a DC current is applied to the input winding, the current applied is turned on and off by a switching element, and an alternating voltage is outputted from the output winding, wherein the inverter circuit is driven at a frequency staying out of the frequency range where the input-output voltage phase difference of the step-up transformer is between 50 and 130 degrees. Consequently, while the power efficiency is lowered by adjusting the turn number of windings, the air gap, and the degree of coupling, the fluctuation of the input and output voltage due to the fluctuation of load impedance is reduced thus stabilizing the oscillation.

However, since the driving method described above is used for lighting one to several CCFLs, it is difficult for one backlight inverter to stably light more CCFLs, for example, typically eight to sixteen CCFLs, in a controlled manner, and the lamp voltages of the individual CCFLs fluctuate thereby causing fluctuation of the currents flowing in the parasitic capacitance of the CCFLs, which makes the brightness unstable thus flickering the screen of the LCD.

Also, in a backlight for a large television, a plurality of CCFLs are disposed behind the LCD, which is called a “direct light type”. In order to achieve a low cost backlight inverter, one control IC is adapted to drive a plurality of FET bridges to each of which a plurality of inverter transformers are connected, whereby the plurality of CCFLs are lit.

The CCFL, when used for a backlight with a plurality of lamps, undergoes a large fluctuation in lamp impedance depending on lamp current, especially immediately after cold starting. The fact that lamp impedance fluctuates largely means that lamp voltage also fluctuates, and consequently current flowing in the parasitic capacitance of the lamp is caused to fluctuate.

In order to address the current fluctuation issue, a backlight inverter to light a plurality of lamps, together with a driving method thereof, is proposed in which current is stabilized without influence of lamp temperature so that the brightness of an LCD screen is stabilized from the very start of lighting a CCFL (refer to, for example, Japanese Patent Application Laid-Open No. 2006-140055.

In the driving method described in Japanese Patent Application Laid-Open No. 2006-140055, the backlight inverter includes a plurality of inverter transformers, has a plurality of CCFLs connected thereto and is driven at an operating frequency which is equal to or lower than a frequency intermediate between a series resonance frequency and a parallel resonance frequency of a resonance circuit including a leakage inductance of the inverter transformer, and an additional capacitance and a parasitic capacitance connected in parallel to each other between the inverter transformer and the CCFL, and also which is equal to or higher than a frequency where a peak of a phase characteristic curve indicating a phase difference between voltage and current of the inverter transformer viewed from the primary side of the inverter transformer is observed, whereby a stable lamp current flows without receiving influence of lamp temperature and the screen brightness of the LCD is kept stable immediately after cold starting.

The driving method disclosed in Patent Document 3, however, has the following problem. FIG. 11 is a graph showing measurement results, obtained by using an impedance analyzer, of gain characteristics and phase characteristics (phase difference between voltage and current at the primary side of the inverter transformer) of the backlight inverter when a quasi-U-shaped CCFL is driven with a plurality of primary windings of the inverter transformer connected in parallel to each other.

As shown in FIG. 11, a peak waveform (a region from a frequency FiL to a frequency FiU) appears between a parallel resonance frequency Fp and a series resonance frequency Fs in the gain characteristic curve, such that the actual gain characteristics vary abruptly to deviate from the gain characteristic curve usually envisioned (refer to line N indicated by a chain line in the figure). It has been experimentally confirmed that such a peak waveform, which does not appear when the primary windings of the inverter transformer are connected in series to each other for driving quasi-U-shaped CCFLs or U-shaped CCFLs, appears when the primary windings of the inverter transformer are connected in parallel to each other for driving U-shaped CCFLs, when the primary windings of the inverter transformer are connected in parallel to each other for driving straight CCFLs by single end driving method, or when the primary windings of the inverter transformer are connected in series or in parallel to each other for driving straight CCFLs by floating driving method, as well as when the primary windings of the inverter transformer are connected in parallel to each other for driving quasi-U-shaped CCFLs as described above.

However, in the driving method described in Patent Document 3, it may possibly happen that in the case of driving a backlight inverter in which such an abrupt variation region as described above occurs in the gain characteristics curve, a frequency included in the frequency range corresponding to the abrupt variation region is set as a driving frequency, in which case fluctuation in lamp current becomes large and therefore the brightness of CCFL becomes unstable thus causing the LCD screen to flicker. Also, at low environmental temperatures, since the variation region has a greater sharpness compared with at ordinary temperatures, the fluctuation is notably larger thereby causing a large irregularity in the brightness distribution.

### SUMMARY OF THE INVENTION

The present invention has been made in light of the above problem and accomplished based on measurement data indicating that an inverter transformer should be driven at an operating frequency which is included in a frequency range between a parallel resonance frequency and a series resonance frequency of a resonance circuit formed at the secondary side of an inverter transformer and also which is not included in a frequency range corresponding to a peak waveform appearing within the above frequency range in the gain characteristic curve of the inverter transformer, and an object of the present invention is to provide a backlight inverter for lighting a plurality of lamps, wherein a stable lamp current flows through a CCFL without receiving influences of lamp temperature thereby stabilizing the brightness of an LCD screen from the start of lighting the CCFL, and is also to provide a method of driving such a backlight inverter.

The following aspects of the present invention are examples for illustrating the composition of the present invention, wherein the present invention is explained on an item-by-item basis in order to allow an easy understanding of the diversified composition of the present invention. The examples are not intended to limit the technical scope of the present invention, and variations in which part of constituent members in each example are substituted or eliminated or in which additional constituent members are provided may be included in the technical scope of the present invention.

In the present invention, the starting point and the ending point of a peak waveform (when swept from the low frequency side) deviating from the gain characteristic curve usually envisioned are referred to as a first inflection point P1 and a second inflection point P2, respectively. Also, the peak waveform includes both a waveform having a peak value (maximum value) in an increasing direction from the gain characteristic curve usually envisioned and a waveform having a peak value (minimum value) in a decreasing direction therefrom

In order to achieve the object described above, according to an aspect of the present invention, there is provided a backlight inverter which includes at least one inverter transformer and to which a plurality of cold cathode fluorescent lamps are connected, wherein a plurality of primary windings of the inverter transformer are connected to each other either in series or in parallel, a resonance circuit including a leakage inductance and capacitance components is formed at the secondary side of the inverter transformer, and wherein the inverter transformer is driven at an operating frequency which is included in a frequency range between a parallel resonance frequency and a series resonance frequency of the resonance circuit and also which is excluded from a frequency range defined between a first inflection point and a second inflection point of a gain characteristic curve of the inverter transformer.

In the aspect of the present invention, the operating frequency may be set to a frequency at which a difference between the maximum and minimum values of a lamp current flowing through each of the plurality of cold cathode fluorescent lamps is 1 mA or less.

In the aspect of the present invention, the lower limit of the operating frequency may be set, at time of floating driving method, to a frequency at which the crest factor (peak-to-rms ratio) of a lamp current at the midpoint of the plurality of cold cathode fluorescent lamps is 1.6 or less, and may be set, at time of single end driving method, to a frequency at which the crest factor of a lamp current at a ground side of the plurality of cold cathode fluorescent lamps is 1.6 or less.

In the aspect of the present invention, the upper limit of the operating frequency may be set to a frequency at which a phase difference between voltage and current at the primary side of the inverter transformer is −45 degrees or more.

In the aspect of the present invention, the series resonance frequency may be determined by the leakage inductance generated from a secondary winding of the inverter transformer and the capacitance components, and the parallel resonance frequency may be determined by a mutual inductance of the inverter transformer, the leakage inductance and the capacitance components.

In the aspect of the present invention, the capacitance components of the resonance circuit may include parasitic capacitances formed at a secondary side circuit of the inverter transformer.

In the aspect of the present invention, the plurality of cold cathode fluorescent lamps may include: a straight lamp composed of one straight lamp; a quasi-U-shaped lamp composed of two straight lamps connected to each other in series; a U-shaped lamp type composed of one bent lamp; or a square U-shaped lamp composed of one bent lamp.

In the aspect of the present invention, the plurality of cold cathode fluorescent lamps may have an inner atmospheric pressure of less than about 8 kPa, and the inverter transformer may be driven at a driving frequency lower than a frequency at which the first inflection point of the gain characteristic curve occurs.

In the aspect of the present invention, the plurality of cold cathode fluorescent lamps may have an inner atmospheric pressure of about 8 kPa or more, and the inverter transformer may be driven at a driving frequency higher than a frequency at which the second inflection point of the gain characteristic curve occurs.

And, in order to achieve the object described above, according to another aspect of the present invention, there is provided a method of driving a backlight inverter which includes at least one inverter transformer and to which a plurality of cold cathode fluorescent lamps are connected, wherein the method includes a step of driving the backlight inverter at an operating frequency which is included in a frequency range between a parallel resonance frequency and a series resonance frequency of a resonance circuit including a leakage inductance and capacitance components and also which is excluded from a frequency range defined between a first inflection point and a second inflection point of a gain characteristic curve of the inverter transformer.

With the backlight inverter and the driving method thereof according to the present invention, a stable current flows through a plurality of cold cathode fluorescent lamps without receiving influence of lamp temperature, and as a result, the brightness of an LCD screen is stabilized even immediately after cold starting.

Also, with the backlight inverter and the driving method thereof according to the present invention, the influence of a parasitic capacitance on lamp current is reduced, and therefore the lamp current in the plurality of cold cathode fluorescent lamps can be better uniformed. Consequently, the flickering on the LCD screen is eliminated.

Further, with the backlight inverter and the driving method thereof according to the present invention, the conversion efficiency ratio of the backlight inverter is enhanced, and therefore the heat generation in the inverter transformer and switching elements to drive the inverter transformer can be reduced. As a result, for example, in a backlight inverter including a plurality of FET bridges with no heat sink, the number of bridges is reduced and so components for a gate driving circuit, a decoupling capacitor, and the like can be reduced. On the other hand, in a backlight inverter including a plurality of FET bridges with a heat sink, the heat sink can be downsized or may even be eliminated, which enables the backlight inverter to be downsized and also to be produced inexpensively.

### BRIEF DESCRIPTION OF THE DRAWINGS

FIG. 1 is a circuitry of a backlight inverter according to an embodiment of the present invention;

FIG. 2 is a circuitry of a control IC in the backlight inverter of FIG. 1;

FIG. 3 is a circuitry of a relevant portion of a resonance circuit formed at a secondary side of an inverter transformer and also an equivalent circuit thereof in the backlight inverter of FIG. 1;

FIG. 4 is a graph of measurement results of gain characteristics and phase characteristics obtained when a low gas-pressure type CCFL is driven in the backlight inverter of FIG. 1;

FIG. 5 is a graph of measurement results of a maximum difference value of a current flowing through each of a plurality of CCFLs in the backlight inverter of FIG. 1;

FIGS. 6A and 6B are graphs of a leave waveform of lamp current, wherein FIG. 6A shows an ideal current waveform having no distortion and FIG. 6B shows a current waveform with distortion;

FIG. 7 is a graph of measurement results of gain characteristics and phase characteristics obtained when a low gas-pressure type CCFL is driven at a different operating frequency in the backlight inverter of FIG. 1;

FIG. 8 is a graph of measurement results of gain characteristics and phase characteristics obtained when a normal gas-pressure type CCFL is driven in the backlight inverter of FIG. 1;

FIG. 9 is a graph of measurement results of gain characteristics and phase characteristics obtained when a normal gas-pressure type CCFL is driven at a different operating frequency in the backlight inverter of FIG. 1;

FIGS. 10A to 10C are circuitries of relevant portions of backlight inverters according to different embodiments of the present invention; and

FIG. 11 is a graph of measurement results of gain characteristics and phase characteristics of a conventional backlight inverter.

### DETAILED DESCRIPTION OF THE INVENTION

Exemplary embodiments of the present invention will hereinafter be described with reference to the accompanying drawings.

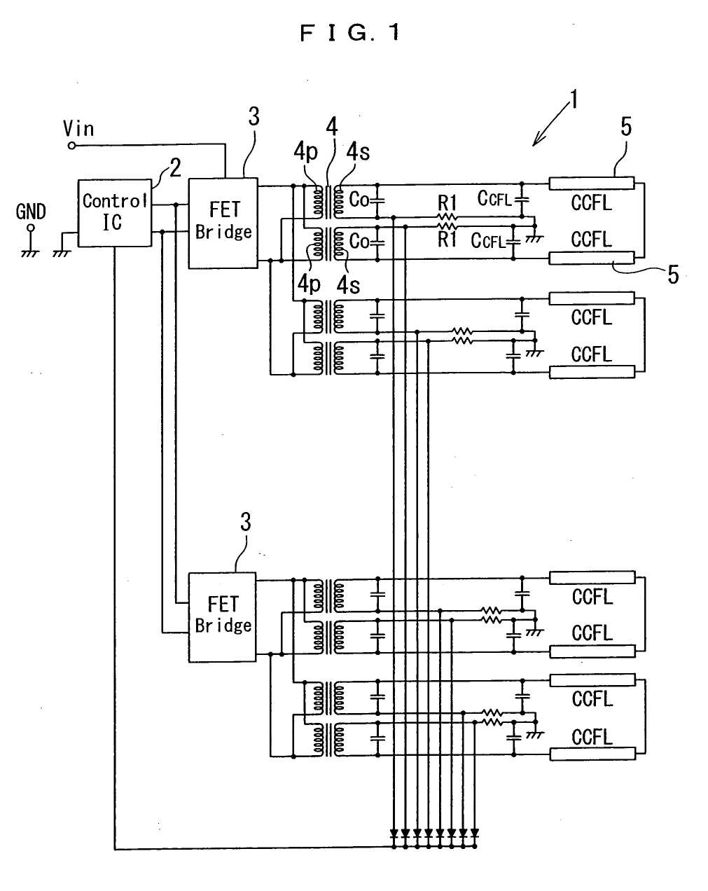

FIG. 1 shows a circuitry of a relevant portion of a backlight inverter 1 according to an embodiment of the present invention. The backlight inverter 1 shown in FIG. 1 is suitable as a backlight for use in, for example, a large LCD TV, and includes a plurality (two in the figure) of FET bridges 3, a plurality (four in the figure) of inverter transformers 4, a plurality (eight in the figure) of CCFLs 5 and one control IC 2, wherein the plurality of FET bridges 3 are activated by the one control IC 2 thereby driving the plurality of CCFLs 5.

The FET bridges 3 are each constituted by, for example, an H-bridge (full-bridge) which is structured such that two series circuits each including a p-MOSFET and an n-MOSFET and are connected in parallel to each other and which drives a load, and are connected to the primary sides of the inverter transformers 4.

The inverter transformers 4 are each constituted by a two-input and two-output leakage transformer which includes two primary windings 4p connected in parallel to each other and two secondary windings 4s provided corresponding respectively to the two primary windings 4p. One ends of the two secondary windings 4s are connected respectively to the both ends of a quasi-U-shaped lamp constituted by two straight CCFLs 5, and other one ends thereof are each connected to ground via a resistor R1. The resistor R1 functions as a current-voltage converting circuit by which a current flowing through the CCFL 5 is converted into a voltage.

In the present embodiment, four primary windings 4p of two inverter transformers 4 are connected in parallel between the outputs of each of the two FET bridges 3, wherein each FET bridge 3 drives two inverter transformers 4, and each transformer 4 drives two CCFLs 5.

Also, parasitic capacitances are present at the secondary side circuit of the inverter transformer 4, specifically parasitic capacitances CCFL formed respectively at the CCFLs 5 and other parasitic capacitances (for example, parasitic capacitances formed respectively at the secondary windings or other wires) C_{O} are shown as equivalent capacitances in FIG. 1.

A voltage Vin from a DC power supply is applied to the FET bridge 3, and a high-frequency voltage is generated according to a drive pulse signal from the control IC 2 and inputted to the primary side of the inverter transformer 4. Then, a boosted voltage is outputted at the secondary side of the inverter transformer 4 and applied to two CCFLs 5 connected to the secondary windings 4s of the inverter transformer 4, whereby the two CCFLs 5 are discharged and lit.

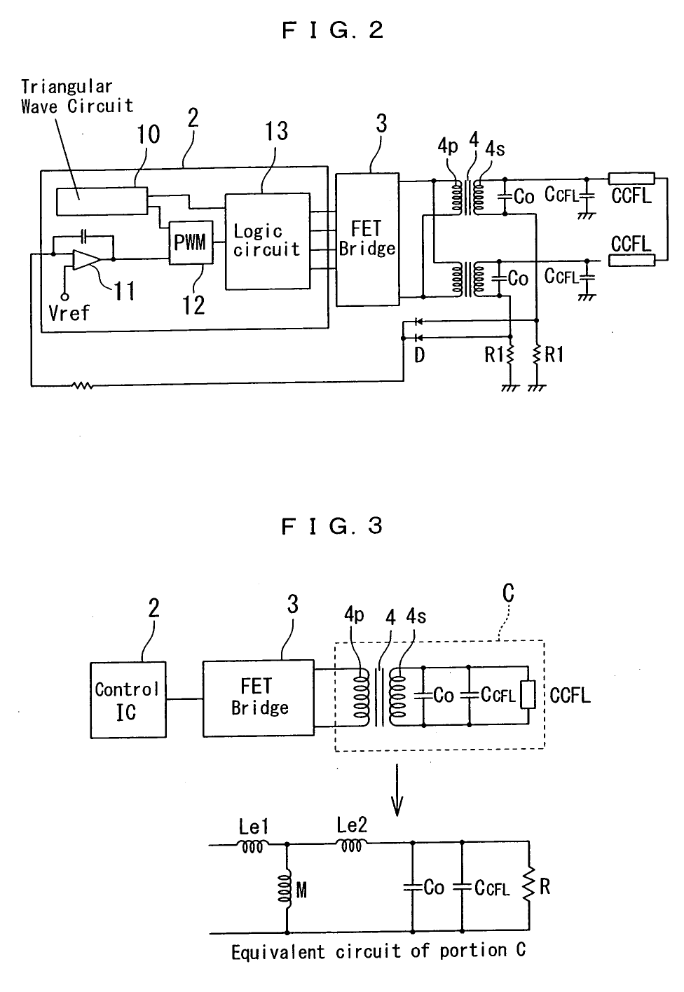

Referring to FIG. 2, the control IC 2 includes a triangular wave circuit (oscillation circuit) 10, an error amplifier circuit 11, a PWM circuit 12 and a logic circuit 13. In the control IC 2, a voltage from the current-voltage converting circuit R1 is inputted via a rectification circuit D to one input terminal (for example, inverting input) of the error amplifier circuit 11, and a predetermined reference voltage Vref is inputted to the other input terminal (for example, non-inverting input) of the error amplifier circuit 11, whereby an output voltage corresponding to a current flowing through the CCFL 5 is generated by the error amplifier circuit 11 and fed to the PWM circuit 12, and the PWM circuit 12 compares a triangular wave output voltage from the triangular wave circuit 10 with the output voltage from the error amplifier circuit 11 and then outputs a pulse signal to the logic circuit 13. The logic circuit 13 outputs a gate signal to the FET bridge 3 according to an output pulse signal from the triangular wave circuit 10 as well as the pulse signal outputted from the PWM circuit 12.

The FET bridge 3 is made to operate by the gate signal outputted from the logic circuit 13, so that an AC current is applied to the primary windings 4p of the inverter transformer 4, whereby a boosted voltage is induced at the secondary windings 4s and the CCFLs 5 are driven.

Description will now be made on a driving frequency for the inverter transformer 4 of the backlight inverter 1.

First, a series resonance frequency and a parallel resonance frequency of the resonance circuit formed at the secondary side of the inverter transformer 4 will be described with reference to FIG. 3. FIG. 3 shows, for illustration purpose, the vicinity of one resonance circuitry portion (area C) in the circuitry of the backlight inverter 1 according to the present embodiment and also an equivalent circuit thereof. In FIG. 3, C_{O} and CCFL refer to the parasitic capacitances described earlier. In the equivalent circuit of the area C, M refers to a mutual inductance of the inverter transformer 4, Le2 refers to a secondary side leakage inductance, and R refers to a lamp impedance of the CCFL 5.

At the secondary side of the inverter transformer 4 in the backlight inverter 1, a resonance circuit is formed which includes the leakage inductance Le2 generated from the secondary winding 4s and the parasitic capacitances C_{O} and C_{CFL} regarded as capacitors equivalently connected in parallel across the secondary winding 4s, wherein its series resonance frequency Fs is given by the leakage inductance Le2 and a combined capacitance of the capacitances C_{O} and C_{CFL} as capacitance components in the present embodiment, and its parallel resonance frequency Fp is given by the mutual inductance M, the leakage inductance Le2 and the capacitances C_{O} and C_{CFL}. Specifically, the series resonance frequency Fs and the parallel resonance frequency Fp are obtained as follows: Fs=1/(2π√(Le2×C)) and Fp=1/(2π29 ((Le2+M)×C)), where C=C_{O}+C_{CFL}.

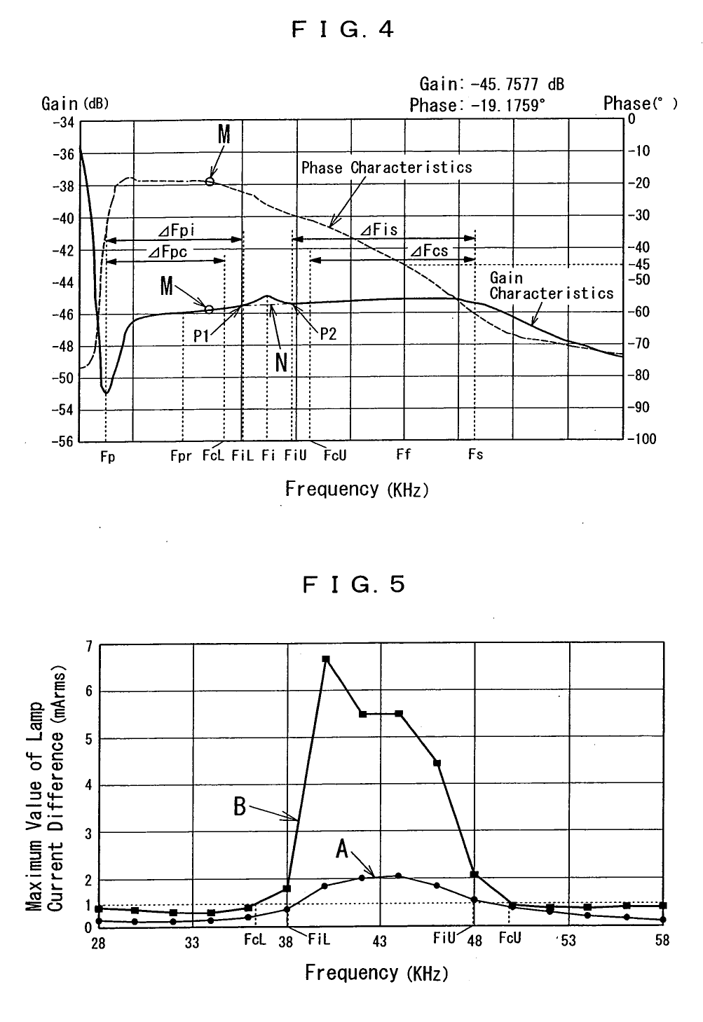

FIG. 4 shows measurement results of gain frequency characteristics and phase frequency characteristics measured using an impedance analyzer for the backlight inverter 1 structured as shown in FIG. 1. “Gain” refers to a ratio between current and voltage at the primary side of the inverter transformer 4 which corresponds to an admittance seen from the primary side of the load of the inverter transformer 4, and “phase” refers to a phase difference between voltage and current at the primary side of the inverter transformer 4.

The frequency characteristics shown in FIG. 4 result from measurement on a low gas-pressure type CCFL used as the CCFL 5. In the present invention, the “low gas-pressure type” CCFL refers to a CCFL which has an inner atmospheric pressure of less than about 8 kPa (about 60 Torr), while a “normal gas-pressure type” lamp has an inner atmospheric pressure of about 8 kPa (about 60 Torr) or more.

Referring to FIG. 4, a peak waveform (a region from a frequency FiL to a frequency FiU) appears between a parallel resonance frequency Fp and a series resonance frequency Fs in the gain characteristic curve, such that the actual gain characteristics vary abruptly to deviate from the gain characteristic curve usually envisioned (refer to line N indicated by a chain line in the figure). In the present invention, the starting point and the ending point of the peak waveform (when swept from the low frequency side) are referred to as a first inflection point P1 and a second inflection point P2, respectively.

Also, in the backlight inverter 1 according to the present embodiment, the inverter transformer 4 is driven at an operating frequency which is excluded from a frequency range defined between the first and second inflection points P1 and P2, more specifically which is included in the frequency range between the parallel resonance frequency Fp and the series resonance frequency range Fs of the resonance circuit while excluded from the aforementioned frequency range between the first and second inflection points P1 and P2. That is to say, the operating frequency for driving the inverter transformer 4 covers a frequency range ( [symbol] Fpi) from the parallel resonance frequency Fp (inclusive) up to the frequency FiL (exclusive) at the first inflection point P1e) and a frequency range ( [symbol] Fis) from the frequency FiU at the second inflection point P2 (exclusive) up to the series resonance frequency Fs (inclusive).

Generally, if the driving frequency is set at a frequency ranging between the first and second inflection points P1 and P2 where gain characteristics exhibit a peak waveform as shown in FIG. 4, then the lamp current flowing through the CCFL 5 fluctuates substantially, and therefore the brightness of the CCFL 5 becomes unstable thus causing the LCD screen to flicker. In the present invention, since the inverter transformer is driven at the operating frequency described above, the lamp current fluctuation is reduced and the brightness is stabilized thus reducing the flickering of the LCD screen.

When the plurality of CCFLs 5 are lit in the use environment where the temperature changes significantly, the operating frequency preferably is further restricted as described below. FIG. 5 shows measurement results of the maximum difference value (difference between the maximum and minimum lamp current values) of the lamp current flowing through each of the CCFLs 5, where A shows the difference value under ordinary temperature (25 degrees C.) and B shows the value under low temperature (−30 degrees C.).

As shown in FIG. 5, in the environment under low temperature the lamp current difference increases drastically not only in the frequency range between the first and second inflection points P1 and P2 (between the frequency FiL and the frequency FiU) but also at the frequencies adjacent to the frequency range, when compared with in the environment under normal temperature. Generally, in order to reduce the variation of the CCFL brightness, the maximum difference value of the lamp current flowing through each CCFL 5 preferably is limited to 1 mA or less. Accordingly, in order to meet the condition in the use environment where the ambient temperature changes significantly, it is preferred that the inverter transformer 4 be driven at an operating frequency excluded from a frequency range between a frequency FcL and a frequency FcU shown in FIG. 5. That is to say, the operating frequency for driving the inverter transformer 4 preferably ranges from the parallel resonance frequency Fp (inclusive) up to the frequency FcL (inclusive) (a range [symbol] Fcs in FIG. 4) or ranges from the frequency FcU (inclusive) up to the series resonance frequency Fs (inclusive) (a range [symbol] Fcs shown in FIG. 4).

When an inverter transformer is driven at an operating frequency set at a frequency falling within the frequency ranges described above, the lamp current fluctuation is reduced and the brightness distribution can be uniformed even in the environment where temperature changes.

Also, in order to lengthen the life of a lamp, it is necessary to minimize the distortion of current, and the lower limit operating frequency preferably is set as follows.

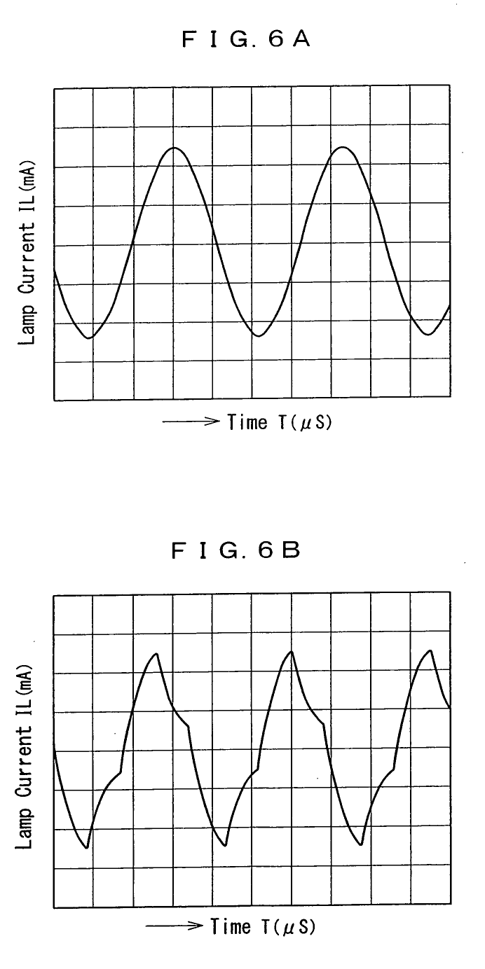

FIGS. 6A and 6B show a waveform of lamp current IL, wherein FIG. 6A shows an ideal current waveform having no distortion and FIG. 6B shows a current waveform with distortion. When the CCFLs 5 are driven by floating driving method as in the backlight inverter 1 shown in FIG. 1, the current waveform is measured at the midpoint between two CCFLs 5.

FIG. 6B shows a current waveform having a crest factor (Io−p/Irms, where Io−p is peak current, and Irms is effective current) of 1.6. In order to prevent as much as possible the lamp current IL from affecting the life of a lamp, the crest factor of the lamp current IL must be 1.6 or less. In this connection, since the crest factor of the lamp current IL exceeds 1.6 at a frequency lower than a particular frequency Fpr (refer to FIG. 4), the inverter transformer, when driven at the frequency region below the first inflection P1, is preferably driven at an operating frequency set at the frequency Fpr or higher.

Thus, by driving the inverter transformer at the operating frequency where the lamp current IL has a crest factor of 1.6 or less, the life of a lamp can be extended. In the floating driving method, if the current waveform is measured at the midpoint between two CCFLs 5, the accuracy of the crest factor measurement is enhanced. Also, when the CCFL 5 with its end connected to ground is driven by single end driving method, the measurement is preferably conducted at the ground side of the CCFL 5.

Next, in order to enhance the conversion efficiency of the backlight inverter 1, the upper limit operating frequency of the driving frequency of the inverter transformer 4 is preferably set as follows.

Since the phase value decreases as the operating frequency becomes closer to the series resonance frequency Fs, the excitation current flowing in the inverter transformer increases thus deteriorating the conversion efficiency. It is experimentally known that if the phase value is set at −45 degrees or more, the conversion efficiency is enhanced, and therefore the inverter transformer is preferably driven at an operating frequency equal to or lower than a frequency Ff (refer to FIG. 4) where the phase value is −45 degrees.

Thus, by setting the phase value of the inverter transformer 4 at −45 degrees or more, the lamp current can also be prevented from fluctuating thereby achieving a uniform brightness distribution while enhancing the conversion efficiency of the inverter transformer 4.

Also, in the case of using a low gas-pressure type lamp, it is preferable for the inverter transformer to be driven at an operating frequency lower than the frequency FiL at the first inflection point P1, and in the case of using a normal gas-pressure type lamp, it is preferable for the inverter transformer to be driven at an operating frequency higher than the frequency FiU at the second inflection point P2. This will be concretely described as follows.

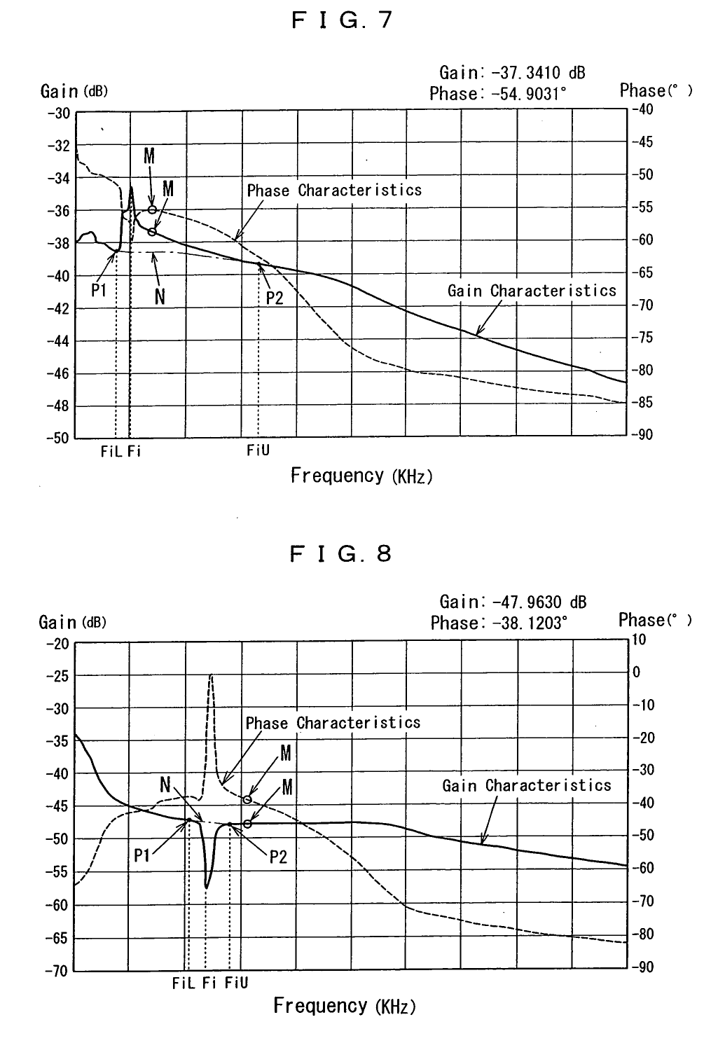

Referring back to FIG. 4, marks M indicate a measurement point at which gain and phase are measured when the inverter transformer is driven at the operating frequency lower than the frequency FiL at the first inflection point P1 in the case of using a low gas-pressure type CCFL, wherein the gain value is −45.7577 dB, and the phase value is −19.1759 degrees. On the other hand, in the gain characteristics and the phase characteristics shown in FIG. 7, marks M indicate a measurement point at which gain and phase are measured when the inverter transformer is driven at the operating frequency higher than the frequency FiU at the second inflection point P2 in the case of using a low gas-pressure type CCFL, wherein the phase value is −54.9031 degrees and therefore the driving efficiency of the inverter transformer is deteriorated, which increases heat generation in the switching element (MOS FET) to constitute the inverter transformer or FET bridge. Consequently, a heat sink is required pushing up costs.

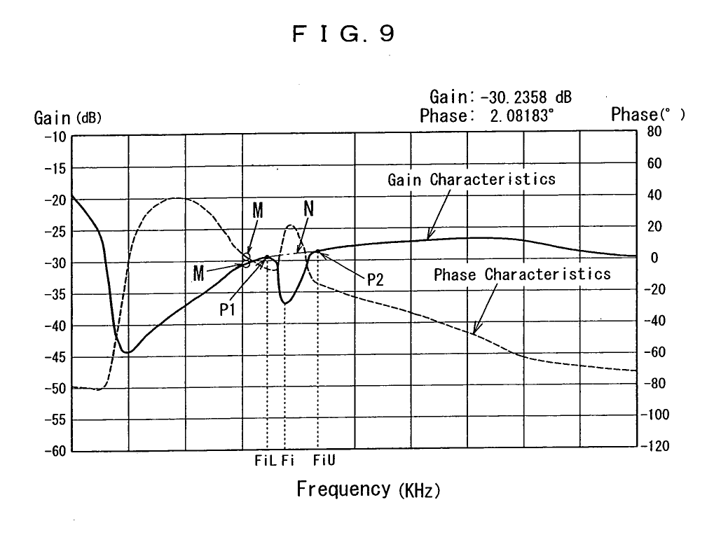

In the gain characteristics and the phase characteristics shown in FIG. 8, marks M indicate a measurement point at which gain and phase are measured when the inverter transformer is driven at the operating frequency higher than the frequency FiU at the second inflection point P2 in the case of using a normal gas-pressure type CCFL, wherein the gain value is −47.9630 dB, and the phase value is −38.1203 degrees. On the other hand, in the gain characteristics and the phase characteristics shown in FIG. 9, marks M indicate a measurement point at which gain and phase are measured when the inverter transformer is driven at the operating frequency lower than the frequency FiL at the first inflection point P1 in the case of using a normal gas-pressure type CCFL, wherein the phase value is 2.08183 degrees suggesting that the inverter operation is unstable.

Thus, the inverter transformer is driven at the operating frequency lower than the frequency at the first inflection point P1 in the case of using a low gas-pressure type CCFL while driven at the operating frequency higher than the frequency at the second inflection point P2 in the case of using a normal gas-pressure type CCFL, whereby the inverter transformer has a good conversion efficiency while achieving a driving capability to provide a stable operation.

The present invention has been described with reference to the typical embodiment but is not limited to the embodiment described above, and various modifications are possible without departing from the spirit of the present invention.

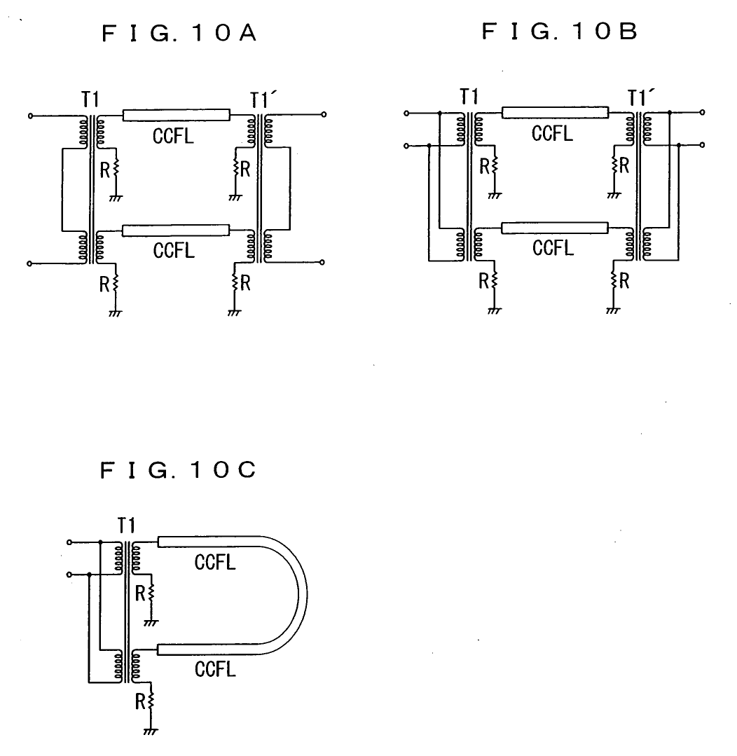

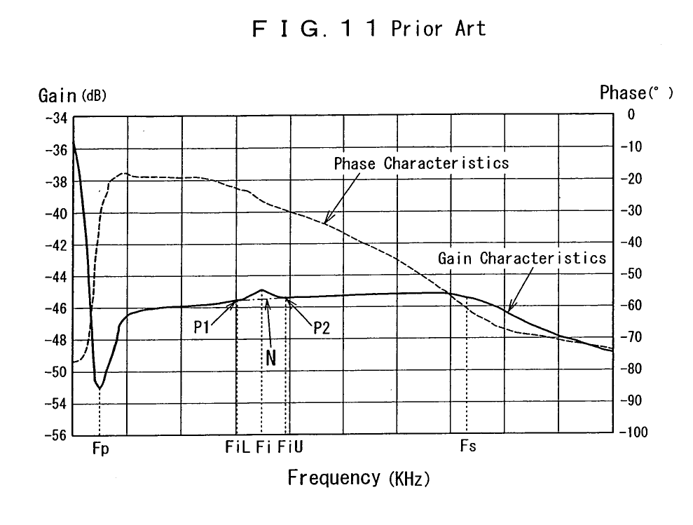

For example, in the embodiment described above, as shown in FIG. 1, the primary windings 4p of the inverter transformer 4 are connected in parallel to each other and two straight CCFLs 5 to be driven are connected in series to each other so as to form a quasi-U-shaped lamp, but the present invention is not limited to such a circuitry arrangement. Referring to FIGS. 10A to 10C, the circuitry may alternatively be arranged, for example, such that: two primary windings of each of two inverter transformers T1 and T1′ are connected in series to each other and one end of each of two straight CCFLs is connected to one end of each of two secondary windings of the inverter transformer T1 while the other end of each straight CCFL is connected to one end of each of two secondary winding of the inverter transformer T1′ as shown in FIG. 10A wherein the CCFLs are driven by floating driving method; two primary windings of each of two transformers T1 and T1′ are connected in parallel to each other and one end of each of two straight CCFLs is connected to one end of each of two secondary windings of each of the inverter transformers T1 while the other end of each straight CCFL is connected to one end of each of two secondary winding of the inverter transformer T1′ as shown in FIG. 10B wherein the CCFLs are driven by floating driving method; or two primary windings of a transformer T1 are connected in parallel to each other and both ends of a U-shaped or square U-shaped CCFL (U-shaped CCFL in the figure) constituted by one bent lamp are each connected to one end of each of two secondary windings of the transformer T1 as shown in FIG. 10C wherein the CCFL is driven by floating driving method.

Further, in the embodiment described above, the capacitance component of the resonance circuit formed at the secondary side of the inverter transformer is constituted by a parasitic capacitance, but the present invention is not limited to such an arrangement and the capacitance component may be constituted by a capacitor which has an appropriate capacitance and which is connected as an additional capacity in parallel across the secondary winding. In this case, the capacitance component of the resonance circuit in the present invention is constituted by a combined capacitance composed of a parasitic capacitance and the aforementioned additional capacitance.

What is claimed is:

1. A backlight inverter to which a plurality of cold cathode fluorescent lamps are connected, the backlight inverter comprising:
at least one inverter transformer comprising a plurality of primary windings, the plurality of primary windings being connected to each other either in series or in parallel; and,
a resonance circuit disposed at a secondary side of the inverter transformer, the resonance circuit comprising a leakage inductance and capacitance components,
wherein the inverter transformer is driven at an operating frequency which is included in a frequency range between a parallel resonance frequency and a series resonance frequency of the resonance circuit and also which is excluded from a frequency range defined between a first inflection point and a second inflection point of a gain characteristic curve of the inverter transformer.

2. A backlight inverter according to claim 1, wherein the operating frequency is set to a frequency at which a difference between maximum and minimum values of a lamp current flowing through each of the plurality of cold cathode fluorescent lamps is 1 mA or less.

3. A backlight inverter according to claim 1, wherein a lower limit of the operating frequency is set, at time of floating driving method, to a frequency at which a crest factor of a lamp current at a midpoint of the plurality of cold cathode fluorescent lamps is 1.6 or less, and is set, at time of single end driving method, to a frequency at which a crest factor of a lamp current at a ground side of the plurality of cold cathode fluorescent lamps is 1.6 or less.

4. A backlight inverter according to claim 1, wherein an upper limit of the operating frequency is set to a frequency at which a phase difference between voltage and current at a primary side of the inverter transformer is −45 degrees or more.

5. A backlight inverter according to claim 1, wherein the series resonance frequency is determined by the leakage inductance generated from a secondary winding of the inverter transformer and the capacitance components, and the parallel resonance frequency is determined by a mutual inductance of the inverter transformer, the leakage inductance and the capacitance components.

6. A backlight inverter according to claim 1, wherein the capacitance components of the resonance circuit comprise parasitic capacitances formed at a secondary side circuit of the inverter transformer.

7. A backlight inverter according to claim 1, wherein the plurality of cold cathode fluorescent lamps comprise one of: a straight lamp composed of one straight lamp; a quasi-U-shaped lamp composed of two straight lamps connected to each other in series; a U-shaped lamp type composed of one bent lamp; and a square U-shaped lamp composed of one bent lamp.

8. A backlight inverter according to claim 1, wherein the plurality of cold cathode fluorescent lamps have an inner atmospheric pressure of less than about 8 kPa, and the inverter transformer is driven at a driving frequency lower than a frequency at which the first inflection point of the gain characteristic curve occurs.

9. A backlight inverter according to claim 1, wherein the plurality of cold cathode fluorescent lamps have an inner atmospheric pressure of about 8 kPa or more, and the inverter transformer is driven at a driving frequency higher than a frequency at which the second inflection point of the gain characteristic curve occurs.

10. A method of driving a backlight inverter which comprises at least one inverter transformer and to which a plurality of cold cathode fluorescent lamps are connected, the method comprising a step of driving the backlight inverter at an operating frequency which is included in a frequency range between a parallel resonance frequency and a series resonance frequency of a resonance circuit comprising a leakage inductance and capacitance components and also which is excluded from a frequency range defined between a first inflection point and a second inflection point of a gain characteristic curve of the inverter transformer.
